(19) United States
(12) Patent Application Publication
(10) Pub. No.: US 2012/0154867 A1
(43) Pub. Date: Jun. 21, 2012

(54) System for Issuing Commemorative Printed Article and Method for Issuing Commemorative Printed Article

(75) Inventors: Mihoko Yamazaki, Shibuya-ku (JP); Hikaru Deguchi, Shibuya-ku (JP); Fujio Yamayaki, Shibuya-ku (JP)

(73) Assignees: MEKIKI CREATES CO., LTD., Shibuya-ku, Tokyo (JP); Mihoko YAMAZAKI, Shibuya-ku, Tokyo (JP)

(21) Appl. No.: 13/391,602

(22) PCT Filed: Aug. 20, 2010
(86) PCT No.: PCT/JP10/64106

§ 371 Date: Feb. 21, 2012

(30) Foreign Application Priority Data
Aug. 20, 2009 (JP) 2009-191281
Aug. 20, 2010 (JP) 2010-185382

(51) Int. Cl. G06K 15/02

(52) U.S. Cl. 358/1.15

(57) ABSTRACT

A member whose membership is registered in a system causes a venue terminal installed on the premises of the service provided by the contractor participating in the system to read a member card, whereupon a system management computer registers a service purchase history for each member formed by mutually associating a member ID and a service ID. When a request is made via a member terminal to the management computer for the commemorative printed article to be purchased, output information formed by integrating service-related information including an official photograph managed by the contractor for the service registered in the purchase history together with individual information including at least the member's name is generated and transmitted to a printing device.

### TECHNICAL FIELD

The present invention relates to a system and method whereby, in order for a user who has benefited from watching a sports event, going to the theatre, or enjoying some other service to commemorate the same at a later date, a medium is imprinted with output information created by integrating user-specific information with information pertaining to the service and with an official photograph from the provider of the service.

### BACKGROUND ART

There have been proposed various systems intended to increase customer satisfaction by giving a commemorative keepsake to customers who have purchased a product or service.

Patent Document 1 and Patent Document 2 are examples thereof. Japanese Laid-Open Patent Publication No. 2005-284399 discloses a “system for issuing a commemorative print” for delivering, to a user using an airplane or the like, a commemorative print serving as a commemoration of the relevant usage, and for providing the user with sense of satisfaction.

Japanese Laid-Open Patent Publication No. 2005-11041 discloses a “system for printing a commemorative ticket and a method for printing a commemorative ticket” by which it is possible to print a commemorative ticket adapted to commemorate participation in various types of events, riding or boarding a vehicle, or the like.

### PRIOR ART DOCUMENTS

### Patent Documents

Patent Document 1 Japanese Laid-Open Patent Publication 2005-284399
Patent Document 2 Japanese Laid-Open Patent Publication 2005-11041

### SUMMARY OF THE INVENTION

### Problem to be Solved by the Invention

However, in the prior art described above, if a photograph specific to the event is to be offered (e.g., for baseball or other sporting event, a photograph featuring a highlight of the match or another subject), the issuing of such a photograph has necessitated waiting until preparations can be made to be able to print the photograph at the premises. Therefore, in a case where the photograph is to be issued at a terminal installed at the premises, long queues inevitably form, waiting times increase, and emotive scenes of the occasion are prevented from being included by practical concerns.

Further, the invention recited in Patent Document merely assumes that the provider of the service will be a single contractor. Therefore, in a case where, for example, a user has traveled, although it is possible to obtain a commemorative print from one of the transportation companies using the system of the invention thereof, it is not possible to obtain a commemorative print from other transportation companies.

The invention recited in Patent Document 2 is also similar in not giving consideration to providing support for a plurality of different services by a plurality of contractors.

Accordingly, in the inventions according to the prior applications, each of the individual contractors deciding to issue a printed article as a commemoration to a user must construct a system. The variety of services provided is extremely diverse. It might be possible for individual contractors who provide users high-volume, high-frequency services to be provided with an individual system; however, it is difficult to provide an individual system in a case of a small theatrical troupe or the like having only, for example, one or two performances per year. Meanwhile, the party who has benefited from a service would wish to keep some form of representation of the service that had left an impression on them (e.g., a tangible printed article).

However, in the aforementioned inventions according to the prior applications, small-scale contracted service providers are also greatly burdened by the need to respond to the desires of a user.

In view of such problems, it is an objective of the present invention to provide a system permitting a contractor who provides a service to issue a printed article as a commemoration of a service desired by a user, with minimal burden and regardless of business type, company size, or other attribute.

### Means for Solving the Problem

To achieve the objective above, a first aspect of the present invention is a system for issuing a commemorative printed article by which, in a case where a member who partners with a contractor providing a service and is issued a membership registration card has purchased the service provided by the partnering contractor, the member can acquire an image-bearing commemorative printed article provided by the partnering contractor, the system for issuing a commemorative printed article characterized in that a computer for managing the system is communicatively connected to a contractor terminal to be used by the contractor, a venue terminal installed at a location where the service is provided, a member terminal to be used by the member, and a printing device for issuing the commemorative printed article; the venue terminal being provided with a retrieving section for retrieving member identification information recorded on the member registration card retained by the member, and a transmitting section for transmitting, to the management computer, the previously retrieved member identification information as well as terminal identification information on the venue terminal, the management computer comprising: an individual member information storing section for storing individual member information together with the member identification information; a contractor information storing section for storing contractor information on the partnering contractor together with the contractor identification information; a venue terminal information storing section for storing the correspondence between the terminal identification information and the service identification information; a service information storing section for storing image data and information pertaining to the service provided by the partnering contractor, in association with the service identification information; a service purchase history storing section for storing the service identification information on the service provided to the member, in association with the member identification information; a service purchase history registration section for seeking, upon receipt of the venue terminal identification information and the member identification information from the venue terminal, the received venue terminal identification information from the venue terminal information storing section, extracting the corresponding service identification information, and registering the extracted service identification information and the received member identification information in mutual association in the service purchase history storing section; s services list drafting section for extracting the service provided to the member from the service information storing section on the basis of the member identification information in response to a request from the member terminal to issue the commemorative printed article, and drafting data for a webpage for displaying the extracted services list and then transmitting the same to the member terminal; and an output information generating section for extracting, upon receipt of selected and specified information on a service and an official photograph thereof from the member terminal via the webpage, the specified service information and official photograph image data from the service information storing section and the individual contractor information storing section, the individual member information also being extracted from the individual member information storing section, and for integrating the extracted items of information and generating data adapted to be outputted by the printing device.

The individual member information storing section stores individual member information (for example, a name and/or home address) together with a member ID.

The individual contractor information storing section stores individual partnering contractor information (for example, a title and/or business address) together with a contractor ID.

The venue terminal information storing section stores a correspondence between a venue terminal ID and a service ID.

The service information storing section stores information pertaining to the service provided by the partnering contractor (for example, a contracted service provider ID, the title of the service, the date, and/or the place provided) and image data of an official photograph, in association with the service ID.

The service purchase history storing section stores the service ID of the service provided to the member, in association with the member ID.

The service purchase history registration section, upon receipt of the venue terminal ID and the member ID from the venue terminal, seeks the received venue terminal ID from the venue terminal information storing section, extracts the corresponding service ID, and registers the extracted service ID and the received member ID in mutual association in the service purchase history storing section.

The services list drafting section extracts the service provided to the member from the service information storing section and the service purchase history storing section in response to a member terminal of a member desiring that a printed article be issued, and drafts data for a webpage for displaying the extracted services list (a list displaying the service title, an official photograph, and the like for each individual service).

The output information section, upon receipt of selected and specified information on the service and the official photograph thereof from the member terminal via the webpage, extracts the specified service information and official photograph image data from the service information storing section and the individual contractor information storing section, and also extracts the individual member information (for example, the name) from the individual member information storing section, integrates the extracted items of information, and generates data adapted to be outputted by the printing device.

The “service” in the present invention not only signifies an intangible product such as a sporting event, concert, or exhibit, but also includes a tangible product. This is because a shop dealing in, for example, luxury brand goods will give various different considerations to the interior decorations of the shop, the product packaging, the ability of the store clerk to assist the customer, and the like; and will accordingly pursue customer satisfaction through tangible products, this being in no way different from a sporting event, concert, or other provided service.

A member whose membership has been registered in the system gains entry and, provided that there is a terminal by which the venue is able to support the system, the member ID on the member registration card is retrieved by a card retrieving unit of the terminal. Notification is thereby given to the system regarding the service purchase history, such as the service from which the member has benefited, and the member is thereby able to obtain a printed article to commemorate the service. In other words, a contracted service provider need not himself set up a database and/or printing section, but rather is able to provide the user with an amenity, such as the system, merely by installing a venue terminal (which may belong to the contractor himself or may be a rental) and registering, in the system, information pertaining to the service, including an official photograph.

A “partnering contractor” refers to a contractor who has an agreement with an administrator of the system pertaining to the use of the system of the present invention. The method of use varies depending on the content of the agreement, and may be a method of continuous use or a method of temporary use.

An “official photograph” refers to image data including a photograph created and sold by the contractor providing the service, and is, for example, a highlighted sporting scene, a famous scene of a play, a portrait photograph of an individual player or actor, or the like.

With stage theater and dance, when a photograph of a famous scene or the like is prepared for all of the performers, then the member can purchase a photograph of a favorite performer, and can have the same experience as in fan voting. A technique for preparing a plurality of photos in this manner and inspiring members to desire to collect the same is effective also as a technique for promoting sales. By preparing a plurality of enticing photos, a contracted service provider can obtain revenue even after having provided the service.

According to the present invention, a member to whom a service has been provided can obtain a commemorative product having intrinsic value with regard to the service.

Further, in a case where the same member has benefited from diverse services that vary depending on the different contractors, a list of the services is displayed on a webpage, and therefore when a service and official photograph are selected on the page, a desired printed article can be purchased. For example, when sporting or classical entertainment, brand product sales, or other different services have been provided, the member can also obtain a commemorative printed article for any of the services by accessing the management computer of the system, without needing to access separate sites.

It may further be possible for a plurality of business types and a plurality of contractors providing various different services to participate.

There is thereby absolutely no limitation to the industry of the contractor or the type of the contractor using the system of the present invention, wherefore it is conceivable that different types of businesses, such as a professional baseball team, an airline company, or a theater troupe administrator, could all participate. In the event that various contractors are introduced to the system in this manner, the system of the present invention provides enhanced convenience. As a result, there can be expected to be a virtuous cycle, meaning that the number of members increases, the number of partnering contractors increases, and the usability of the system is further improved.

The service purchase history registration section may further register, in the service purchase history storing section, information transmitted from the member terminal, the transmitted information containing a seating number at which the service was provided, a message for the member or an affiliated person, and image data created by the member.

The value as a commemorative product for the member is thereby further increased.

An “affiliated person” refers to, for example, a person to whom an entry ticket is presented, and a message that has been additionally written on the ticket also remains imprinted on the commemorative product.

The data adapted to be outputted by the printing machine may also have a shared format for all services provided by the partnering contractors.

The processing done by the output information generation section is thereby performed uniformly even when there is a plurality of contractors and a plurality of business types.

The management computer may be managed and administered by a social network service (SNS) administrator, the members then being SNS members.

The relevant SNS can then thereby increase the number of members by the use of the system. In the event that the name and home address have been registered and a member ID has been acquired at the time of enrolling in the SNS, then the system can subsequently be used by merely submitting the member ID. Further conceivable is a secondary method of use by which SNS members are capable of a mutual exchange of information on services provided.

The aforesaid objective is also achieved using a method for causing the computer to operate as the management computer of the system for issuing a commemorative printed article, and a computer program adapted to cause the computer to execute the method.

### Advantageous Effects of the Invention

A member to whom a service has been provided can purchase a commemorative product imprinted with an official photograph taken by the contracted service provider and the member's own name or other individual information. The contractor is further able to readily implement such a member amenity by using the system of the present invention.

### BRIEF DESCRIPTION OF THE DRAWINGS

FIG. 1 is a drawing showing the configuration of a system of an embodiment;

FIG. 2 is a block diagram of the functions of the management computer and the venue terminal of an embodiment;

FIG. 3 is a drawing illustrating an example of a configuration of the individual member information database of an embodiment;

FIG. 4 is a drawing illustrating an example of a configuration of the individual contractor information database of an embodiment;

FIG. 5 is a drawing illustrating an example of a configuration of the service information database of an embodiment;

FIG. 6 is a drawing illustrating an example of a configuration of the venue terminal information database of an embodiment;

FIG. 7 is a drawing illustrating an example of the data registered in the service purchase history storing section of an embodiment;

FIG. 8 is a drawing illustrating an example of the main screen display of the system of an embodiment;

FIG. 9 is a flow diagram from the request for, to the issuance of, a commemorative printed article by a member in an embodiment;

FIG. 10 is a drawing illustrating an example of the screen display for a list of services for separate members in an embodiment;

FIG. 11 is a drawing illustrating an example of the screen for input by a member in an embodiment;

FIG. 12 is a drawing illustrating an example of the output format for a printed article in an embodiment;

FIG. 13 is a drawing illustrating an example of a printed article of an embodiment;

FIG. 14 is a drawing illustrating an example of a printed article of an embodiment;

FIG. 15 is a drawing illustrating an example of a printed article of an embodiment;

FIG. 16 is a flow diagram of the processing, mainly in the venue terminal, of a second embodiment; and

FIG. 17 is a flow diagram of the processing, mainly in the member terminal, of a third embodiment.

### MODES FOR CARRYING OUT THE INVENTION

### 1. First Embodiment

The system of an embodiment of the present invention (hereinafter “the system”) shall now be described, with reference to the accompanying drawings.

{1-1. Configuration of the System}

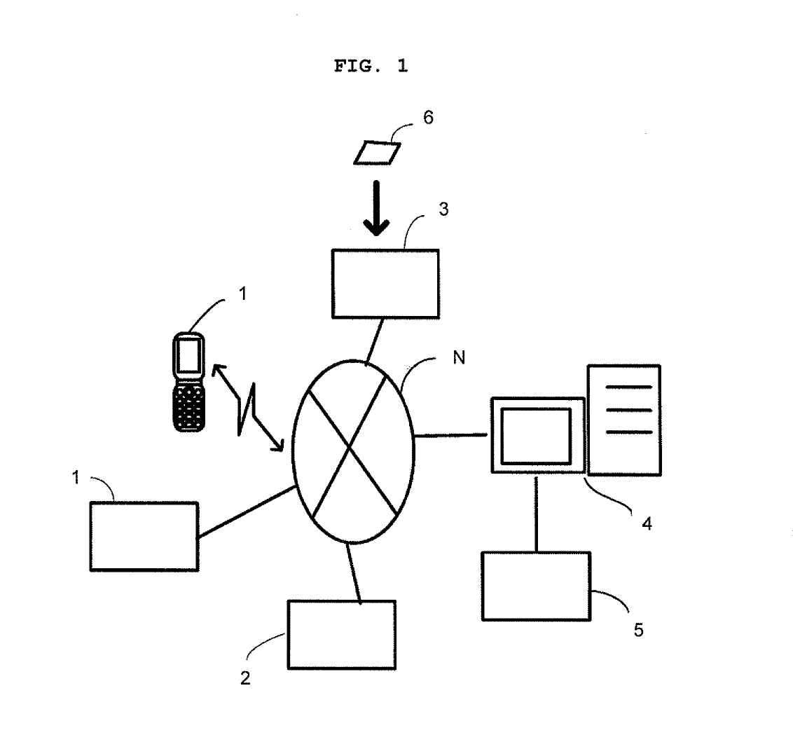

As illustrated in FIG. 1, the system is configured to include a member terminal 1, a contractor terminal 2, a venue terminal 3 installed in the interior of service provision premises, a management computer 4 managed and administrated primarily by a system administrator, and a printing device 5 for issuing a commemorative printed article.

The member terminal 1, the contractor terminal 2, and the venue terminal 3 are connected to the management computer 4 via the Internet N and, when necessary, a mobile communication network (not shown).

The management computer 4 is connected to the printing device 5.

The member terminal 1 is an information processing device to be used by a member, and may be either a portable telephone, a PC, or a PDA, provided that communication with the management computer 4 is possible. However, depending on the printed information (which is, for example, a seating number), it is better to retrieve a QR Code™ to be imprinted on a ticket stub or a receipt. In such a case, it is convenient for the member terminal 1 to be a portable telephone or PC having a camera function by which the QR code can be retrieved.

The contractor terminal 2 is an information processing device to be used by a contractor, and may be either a portable telephone, a PC, or a PDA, provided that communication with the management computer 4 is possible, but a PC is suitable because the contractor will have a need to manage the official photograph.

The venue terminal 3 is an information processing device provided with a member ID retrieving section 3a for retrieving a member ID written on a member registration card 6, and a member ID transmitting section 3b for transmitting the retrieved member ID to the management computer 4. The member ID retrieving section 3a refers to a so-called “card reader,” and the type of the member registration card 6 includes but is not particularly limited to an IC card or a magnetic card. The member ID may be in the form of a barcode or may be in the form of a QR code or other two-dimensional barcode.

Although only two member terminals 1, one contractor terminal 2, and one venue terminal 3 are depicted in FIG. 1, there is no limitation on the quantities thereof.

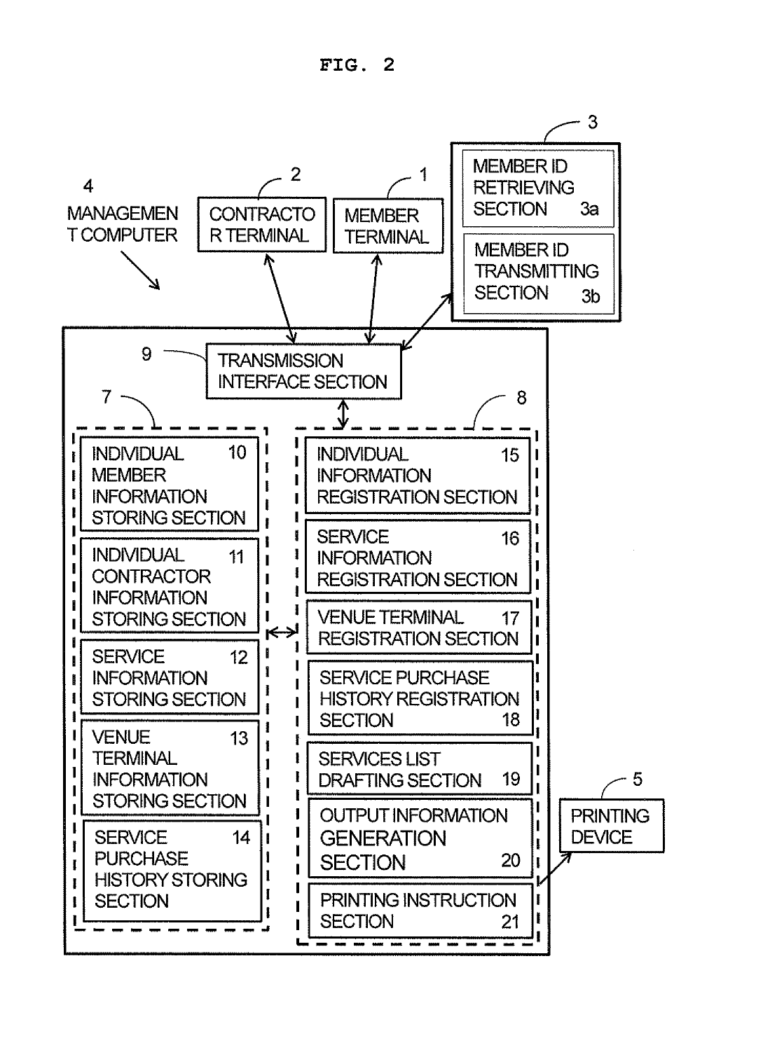

The management computer 4, as illustrated in FIG. 2, is configured to include a storing unit 7, a processing unit 8, and a communication interface 9.

The storing unit 7 contains an individual member information storing section 10, an individual contractor information storing section 11, a service information storing section 12, a venue terminal information storing section 13, and a service purchase history storing section 14.

The processing unit 8 contains an individual information registration section 15, service information registration section 16, venue terminal registration section 17, service purchase history registration section 18, services list drafting section 19, an output information generation section 20, and printing instruction section 21.

However, each of the sections is so classified for the sake of facilitating description only.

Each of the sections is implemented using hardware or software, in accordance with the respective function thereof. In a case where software is used, a CPU executes a computer program installed on a ROM, hard disk, or other storing section; such sections are a matter of public knowledge and description thereof has thus been omitted.

The communication interface 9 communicates with other information processing devices via a communication network.

Though not shown in FIG. 2, the management computer 4 is provided with a storing section on which are installed intermediate working data, parameter types, printed article formats, and other forms of data involved over the course of processing. The management computer is also provided with a keyboard, display, or other input and output sections and drivers, but such elements are also a matter of public knowledge, and a description thereof has thus been omitted.

The individual member information storing section 10 is intended to create a database in which to store individual member information, including at least the names of the members. The individual member information is registered in association with the member ID, which is generated by the system whenever there is a request for member registration from the member terminal 1.

The system issues the member registration card 6, on which the member ID is written, to the person who has been registered as a member.

The individual contractor information storing section 11 is intended to create a database in which to store information specific to a contracted service provider who wishes to use the system to sell a commemorative printed article to customers. The individual contractor information is registered in association with a contractor ID, which is generated by the system whenever there is a request to participate in the system from the contractor terminal 2.

The service information storing section 12 is intended to create a database in which to store information pertaining to the service that is provided by the partnering contractor. The information pertaining to the service includes data for a desired number (one or more) of official photographs. A service ID for a given service is generated when information regarding the given service is first transmitted from the contractor terminal 2 to the management computer 4, Typically, the service information is transmitted from the contractor terminal 2 at a time prior to when the service is provided (in the case of, e.g., a theater, such a time is the point in time when the play, date, and location were decided upon), but after the service is provided, photograph data for a highlight scene may also be registered, or a pre-registered photograph may be replaced with another photo. In such a case, the service information is added as an update in association with the initially generated service ID.

The venue terminal information storing section 13 is intended to create a database in which to mutually associate and store the service ID of the relevant service and the venue terminal ID of the venue terminal 3 installed within the service provision premises. The venue terminal ID is generated by the system, but machine-specific information may also be used as the venue terminal ID.

The service ID related to the venue terminal 3 is to be updated whenever there is a change to the service provided at that location. The venue terminal ID and the service currently being provided at the location are thereby brought into a state of always being mutually related.

The service purchase history storing section 14 is intended to create a database in which to store the correspondence between a member and a service provided to that member. The venue terminal ID and the member ID, upon being transmitted from the venue terminal 3 to the management computer 4, are registered by the service purchase history registration section 18. As will be described later, when a seating number and/or message has been transmitted from the member terminal 1, such items of information are also registered.

The services list drafting section 19, upon receipt of a request from the member terminal 1 that a printed article be issued, drafts an HTML file for expressing the service purchase history of the relevant member in the form of a webpage, which is then transmitted to the member terminal 1.

The output information generation section 20 performs processing in which information pertaining to the services selected by the user as well as user-specific information, including the name, which has been extracted from the individual member information storing section 10, are extracted from the service information storing section 12 and the service purchase history storing section 14, such items of information then being integrated to generate output information.

The printing instruction section 21 performs processing in which the output information generated by the output information generation section 20 is transmitted to the printing device 5.

The printing device 5 receives the output information transmitted from the management computer 4 and imprints the same on a card, seal, or other output medium.

The above is the configuration of the system.

{1-2. Operation of the System}

A description of the operation of the system will follow, but first, the data structure and processing for registering the data in the database required in the system will now be described.

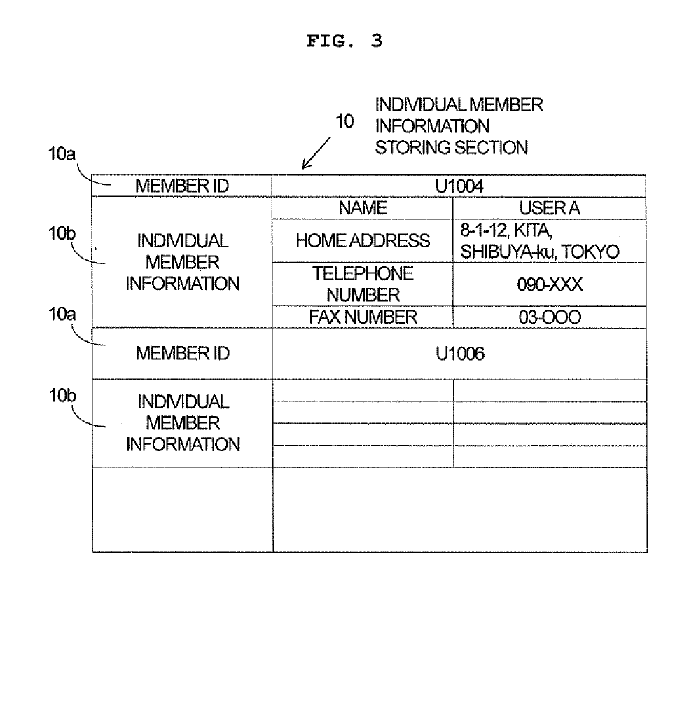

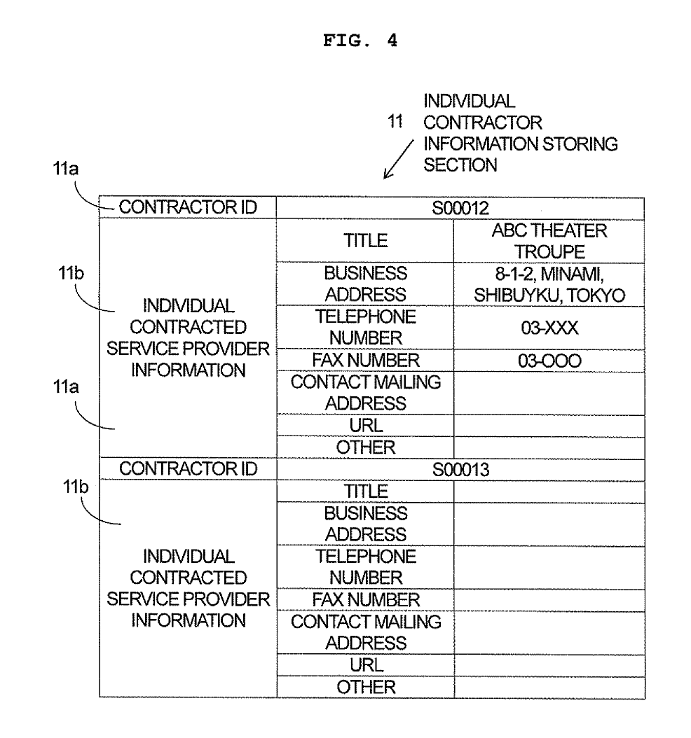

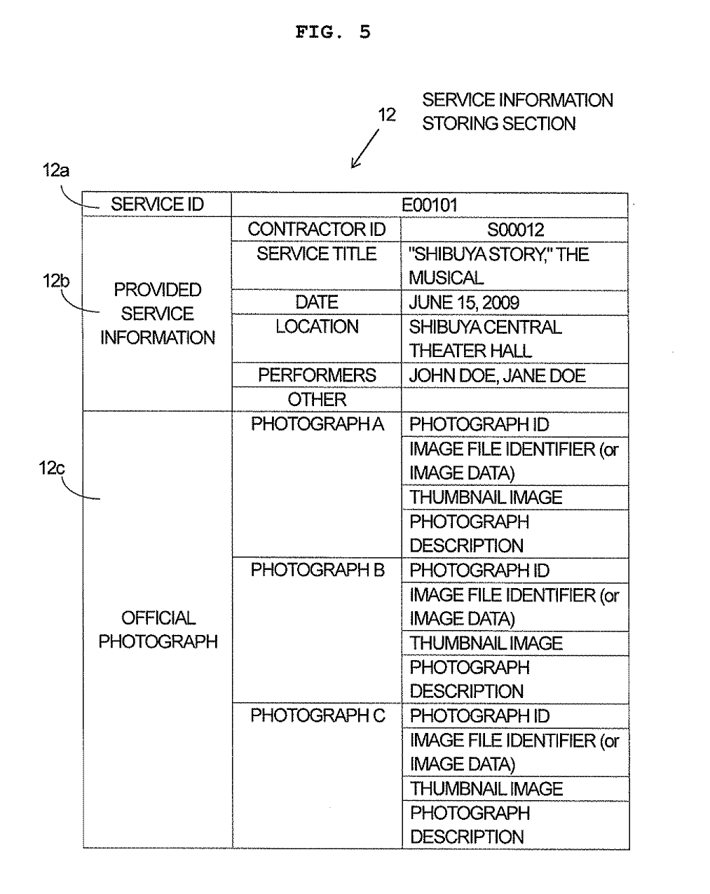

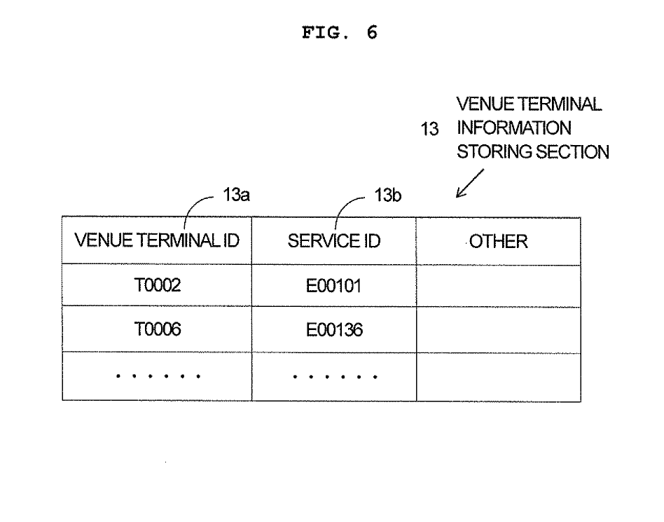

FIG. 3 illustrates an example of an individual member information database; FIG. 4 illustrates an example of an individual contractor information database; FIG. 5 illustrates an example of a service information database; and FIG. 6 illustrates an example of a venue terminal information database. The individual member information storing section 10, the individual contractor information storing section 11, the service information storing section 12, and the terminal venue information storing section 13 are respectively installed in the databases.

In FIG. 3, the individual member information database comprises the member IDs (10a) and the individual member information (names, home addresses, and the like) 10b.

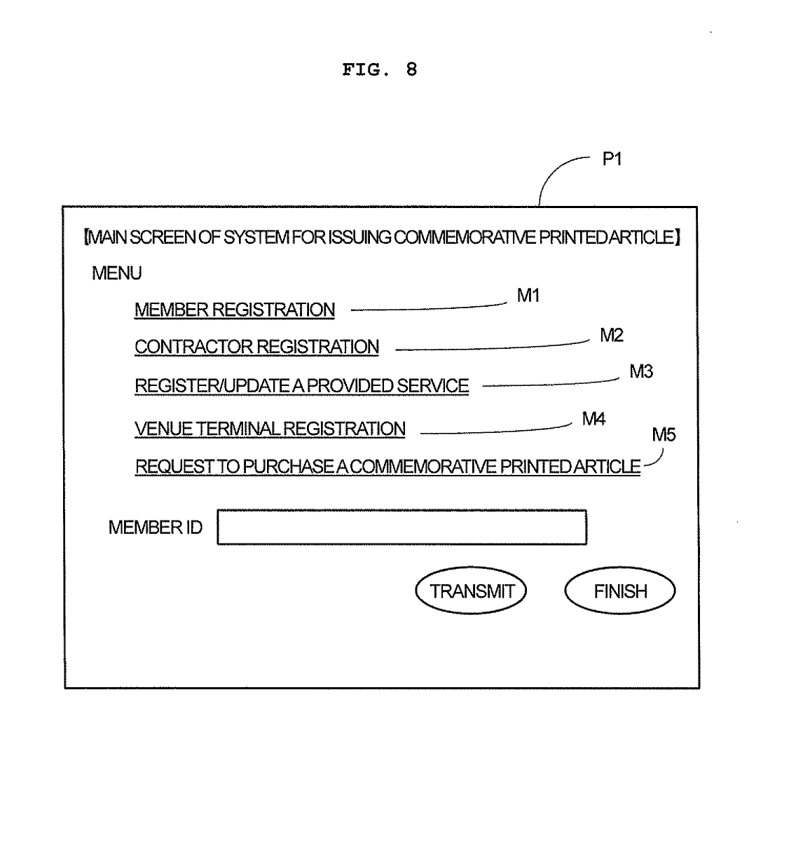

A person desiring the amenity of this system needs to have a membership registered and needs to be issued a member registration card. For that purpose, a menu item “MEMBER REGISTRATION” (M1) is selected from a main screen (P1) of the system, illustrated by way of example in FIG. 8, the system then transitioning to a screen for member registration (not shown) from which the name, home address, and/or other individual information is inputted. The individual information registration section 15 registers the inputted information in the individual member information database 10 in association with the member ID generated upon receipt thereof. An SNS system may also conceivably provide the system of this embodiment as a part of the membership amenities; in such a case, the information registered upon enrollment in the SNS may be re-appropriated as the individual member information to be registered in the individual member information database 10.

In FIG. 4, the individual contractor information database 11 comprises contractor IDs (11a), and individual information specific to each contractor (title, business address, telephone number, and other items of information) 11b.

For the individual contractor information to be registered at the contractor terminal 2, a menu item “CONTRACTOR REGISTRATION” (M2) is selected from the main screen (P1) of the system, the system then transitioning to a screen for contractor registration (not shown) from which the title, business address, and other contractor-specific information is inputted. The individual information registration section 15 registers the inputted information in the individual contractor information database 11 in association with the contractor ID generated upon receipt thereof.

In FIG. 5, the service information database 12 comprises service IDs (12a), provided service information (contractor ID, service title, date, location, and other items of information) 12b, and data 12c for a desired number (one or more) of photos.

The service information is registered as follows. A menu item “REGISTER/UPDATE A PROVIDED SERVICE” (M3) is selected from the main screen (P1), the system then transitioning to a screen for registering or updating a service (not shown), from which the title of the service (which may be, for example, “Hamlet” for a theater performance, or “Major League Baseball Match” for a baseball game), the date the service was provided, the location at which the service was provided, official photograph data, and other items of information are inputted. The service information registration section 16 registers the inputted information in the service information database 12 in association with the generated service ID.

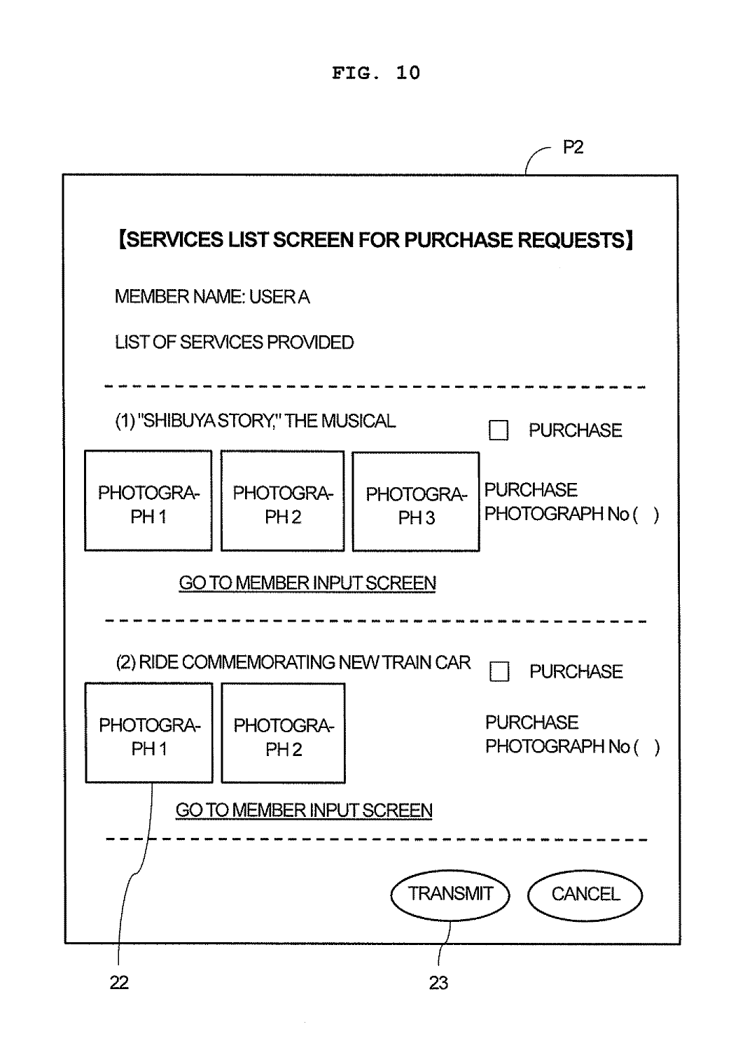

As illustrated in FIG. 5, the photograph data 12c comprises a photograph ID, an image file identifier, thumbnail image data, and a description of the photo. The image file identifier is intended to indicate the location at which digital data for the photograph information expressed by the photograph ID is kept, and is, for example, an item of information called either the filename or the path name. However, instead of the file identifier, it would further be possible to install the actual digital data on the service information storing section 12. The thumbnail image data is displayed as a list for the member (see FIG. 10) and is displayed on a screen of the member terminal 1 when a favorite photograph is to be selected. The reason for preparing the thumbnail image data separately from the original image data, which has a large data size, is that there could conceivably be many members using portable telephones as the member terminal 1.

Herein the photograph data is typically provided by the contractor, there being a plurality of different photos stored for the same service. When a plurality is stored, the breadth of selection increases and the experience is more enjoyable for the members. When attractive photos can be provided, the system will be used more, and the contractor will also obtain revenue from the product sales in addition to the cost of entry for the service provided.

The photograph data may be registered either before or after the service is provided, and a photograph may be replaced as appropriate during the sale. In a case where there are many photos, there may be further provided a photograph search function.

In FIG. 6, the venue terminal information database 13 comprises IDs (13a) for the venue terminals 3 installed in the interior of the service provision premises, and the service IDs (13b) for specifying the relevant service.

The venue terminal 3 is registered as follows.

The venue terminal 3 is pre-assigned a venue terminal ID. A contractor who installs the venue terminal 3 on the service provision premises transmits the service ID together with the venue terminal ID to the management computer 4. Typically, the contractor terminal 2 has a main screen (P1) from which “VENUE TERMINAL REGISTRATION” (M4) is selected, the system then transitioning to a screen (not shown) from which the venue terminal ID and the service ID are inputted and transmitted. Alternatively, such information may be transmitted to the management computer 4 directly from the venue terminal 3, rather than being transmitted via the contractor terminal 2.

The processing for registering a service provided to a member into the service purchase history storing section 14 will be described next. The following description makes reference to the data illustrated by way of example in FIGS. 3 to 6.

The member goes to the service provision premises and causes the member ID retrieving section 3a of the venue terminal 3 installed in the premises to read the member registration card 6. The member ID transmitting section 3b of the venue terminal 3 transmits the member ID and the relevant terminal ID to the management computer 4.

To specify the date and time at which the service was provided, the date and time at which the venue terminal 3 retrieved the member registration card 6 may also be transmitted. Further, the management computer 4 may acquire the date and time at which the member ID was received from the venue terminal 3.

In a case where a plurality of services having identical content are provided on the same day, as occurs with, e.g., movies, it will thereby be possible to specify which was the screening.

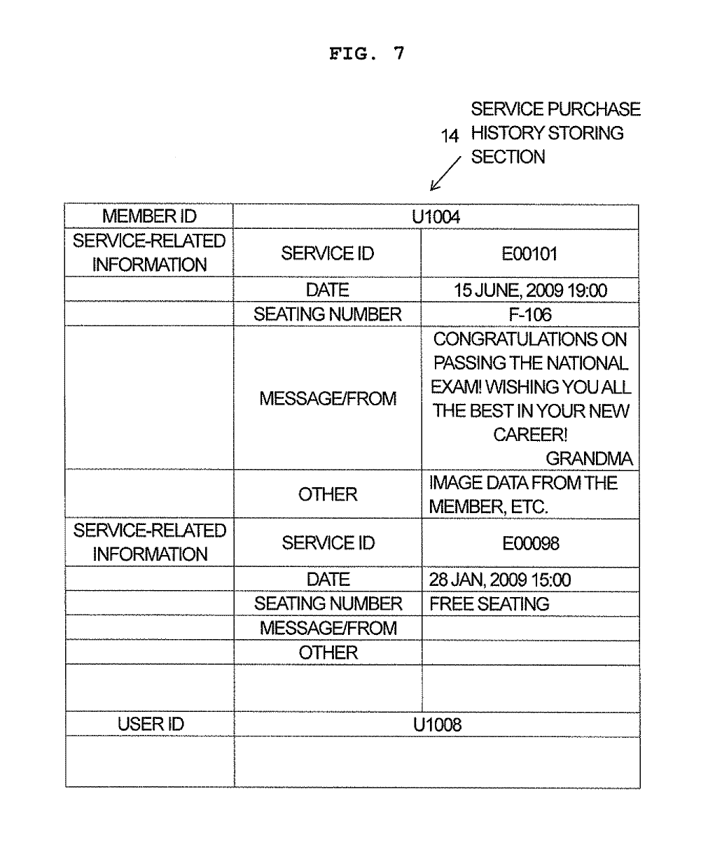

In a case where a user A (ID=U1004) causes the venue terminal 3 (ID=T0002) to read the member registration card, the venue terminal 3 transmits the relevant ID (T0002) and the member ID (U1004) to the management computer 4. The management computer 4 seeks the venue terminal ID (T0002) from the data in FIG. 6, and extracts a service ID (E00101). Next, as illustrated by way of example in FIG. 7, the service ID (E00101) is registered in the service purchase history storing section 14 as the service purchase history of the user A (ID=U1004). In so doing, only the person who registered using the venue terminal 3 will be entitled to obtain the commemorative printed article.

It is not important whether the service provided is tangible or intangible. For example, a gallery or other exhibition can often be enjoyed by all, for free. When a gallery owner registers as a contractor in the system and a venue terminal 3 is installed, a member who has enjoyed the exhibition may merely cause the venue terminal 3 to retrieve the member registration card 6.

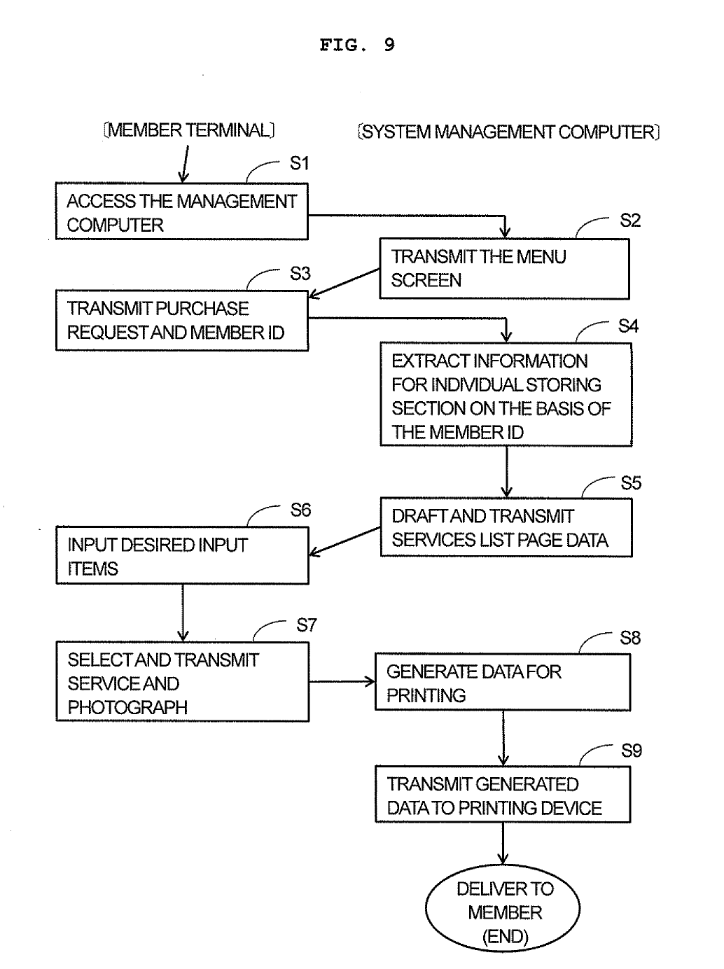

Next, the flow of the processing from when the member requests to purchase the commemorative printed article until the issuance thereof will be described, with reference to FIG. 9. Herein, the description assumes a case where the “user A” (member ID=U1004) purchases a commemorative printed article for a service in which he has participated.

When the management computer 4 is accessed from the member terminal 1 (step S1), the main screen (P1) as in FIG. 8 is transmitted to the management computer 4 (step S2), and displayed on a screen of the member terminal 1. “REQUEST TO PURCHASE COMMEMORATIVE PRINTED ARTICLE” (M5) is selected from the menu, and the relevant member ID is inputted and transmitted to the management computer 4 (step S3).

The services list drafting section 19 of the general computer 4 uses the received member ID (U1004) as a key to search the individual member information storing section 10 and extracts the name (“User A”), further extracting the IDs of the services provided to the user A (E00101 and E00098) from the service purchase history storing section 14 and also extracting the service content associated with the service IDs from the service information storing section 12 (step 4). On the basis of the extracted information, the management computer 4 drafts webpage data for displaying the services list and transmits the same to the member terminal 1 of the user A (step S5).

The screen of the member terminal 1, which has received the webpage data, displays a webpage (P2), as in FIG. 10. Thumbnail images 22 and other items of information are also displayed in association with the photograph IDs in order to allow the member to select the photograph he wishes to purchase.

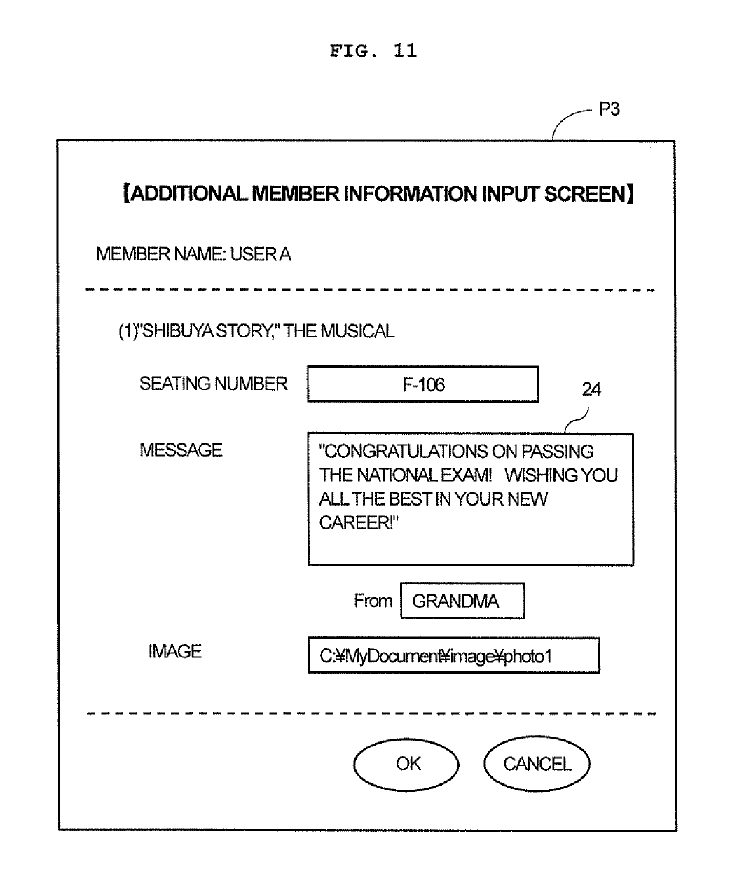

In a case where the member wishes to print information specific to himself, the system transitions to an input screen (P3) illustrated by way of example in FIG. 11, where it is possible to input a seating number, a message, an image, or other piece of information (step S6). The seating number may be inputted through the keypad, or a camera function of the member terminal 1 may be used to read and transmit a QR code imprinted on the ticket stub or the like. The reason for making it possible to input a message is that there will be greater value as a commemoration at a later date. The ticket from the service may also be given as a present. In a case where a message card is attached along with the ticket, the gift-giver may input a message. In the example in FIG. 11, a message 24 from a grandmother is inputted.

In a case where the member wishes to haven an impression of a photograph he has taken, the same can be transmitted to the management computer 4. When the input of additional information has finished, the system returns to the original screen (P2) illustrated by way of example in FIG. 10, and any one service and official photograph desired for purchase is selected; when a transmission button 23 on the webpage is clicked, the IDs of the selected service and official photograph are transmitted to the management computer 4 (step S7). The information inputted in step S6 via the screen P3 is also transmitted at the same time. The management computer 4 registers the information inputted by the member into the service purchase history storing section 14 (see FIG. 7). There may possibly be a plurality of requests for commemorative printed articles to be printed for the same service.

The output information generation section 20 of the management computer 4 extracts specific information pertaining to the selected service as well as the single selected official photograph data, from the service information storing section 12. Extracted information, member name, information inputted by the member (for example, the seating number) and other items of information specific to the user are integrated and data for imprinting is generated (step S8). Herein, as appropriate, there may be processing in which the generated data is transmitted to the member terminal 1 and confirmation is requested or there is a prompt for the user to input the address to which the printed article is to be sent and/or the payment method.

The printing instruction section 21 of the management computer 4 transmits the generated data to the printing device 5 (step S9). The series of operations by the management computer 4, from when the member made a request to the issuance of the printed article, is thereby terminated.

Possible mediums for the outputted information to be imprinted on include a slip of paper or a card, sheet, or film made of plastic, which may contain a “seal” having an adhesive layer provided on the rear surface or similarly having a magnet provided to the rear surface. In other words, any medium may be used, provided that printing is possible. A rectangular or ellipsoidal shape may be employed.

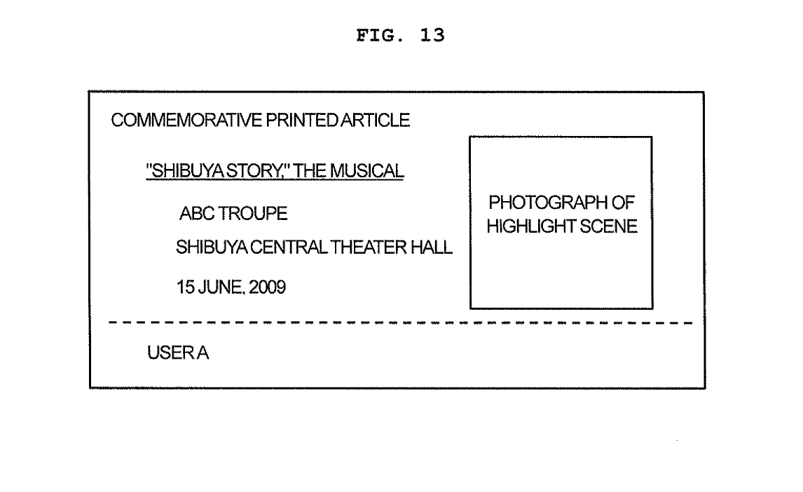

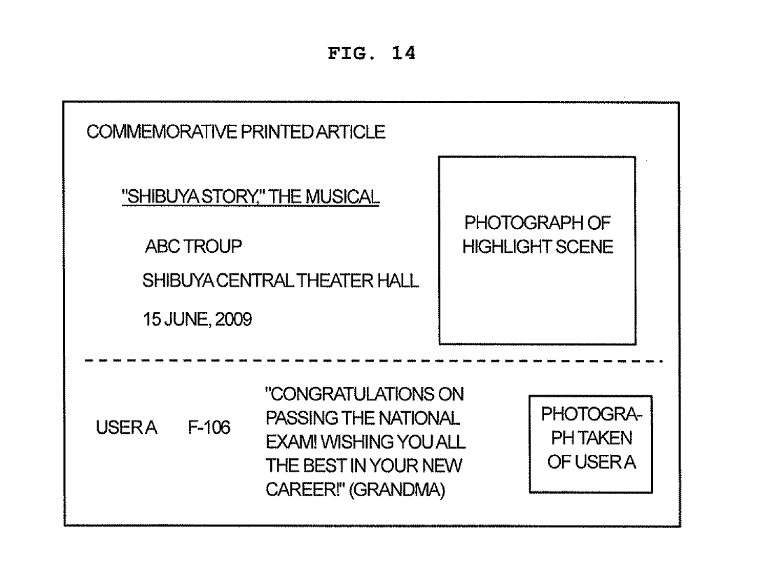

FIGS. 13 and 14 illustrate examples of commemorative products printed and issued by the printing device 4. FIG. 13 is an example of a case where the processing in step S6 has been omitted; at least the member name has been printed, and so the commemorative product has value only for the actual member. FIG. 14 is an example of a case where the user has inputted additional information in step S6; the commemorative product then has a deeper sentimental value. The message may be a message the member has addressed to himself. The member's sentiments regarding the service have been imprinted, so the commemorative product is an alternative to a diary entry when taken out and beheld at a later date.

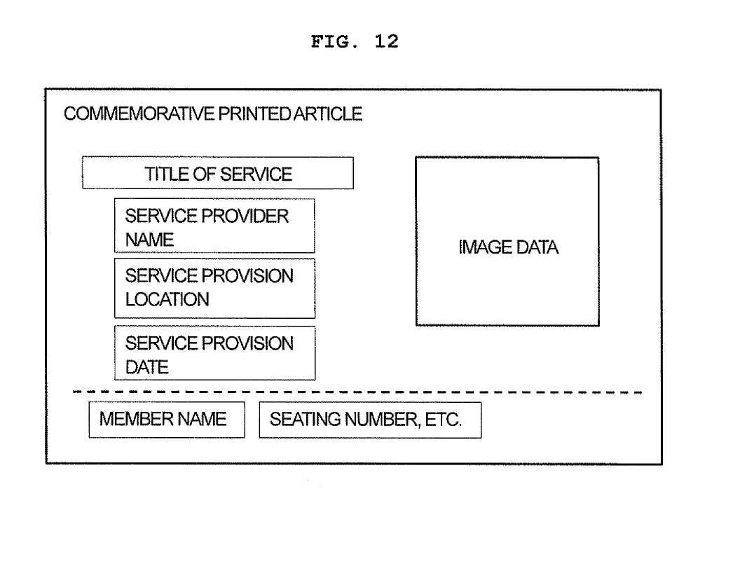

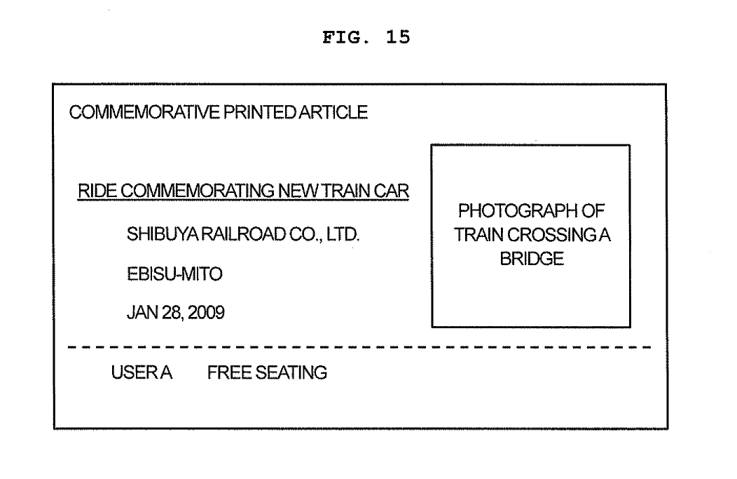

Herein, the format of the printing data is not to be particularly limited. However, it is preferable to employ a uniform format irrespective of the type of service. For example, the format of the printed article is as in FIG. 12. As will be understood from comparing FIGS. 13 to 15, even though the type of service is different, being the enjoyment of a theater performance and a train ride, the format of the outputted printed articles is shared.

The system assumes that a plurality of different contractors will be associated with a plurality of different services. The system is rendered complex when individual contractors and services are of a different format, but when the formats are thus made uniform, the system is more readily developed and maintained. The system is thereby more readily introduced by small- or medium-scale SNS administrative bodies and the like. Having the same format and the same shape and size for the printed articles is also advantageous when sorting into albums or the like.

However, it is also possible to pre-emptively prepare a plurality of formats and cause the contractor to select one of the formats.

### 2. Second Embodiment

This embodiment differs from the first embodiment in that the member is able to input a seating number upon gaining entry. The following is a description of the points of difference from the first embodiment. Like reference numerals are used for like functions from the first embodiment.

In this embodiment, the venue terminal 3 is also provided with a seating information retrieving section (not shown) for retrieving a QR code and extracting seating information. The venue terminal 3 is additionally provided, when appropriate, with a screen display section and an input section (not shown). The “seating information” herein refers primarily to a seating number, but sometimes no seat is designated, as with standing-room viewing, wherefore the type of seat may also be designated seating, free seating, or standing-room viewing. The QR code may be imprinted on the ticket or on the stub thereof, or may be imprinted on the receipt at the time of ticket purchase. However, it is necessary to predetermine how the seating information is to be written with the QR code.

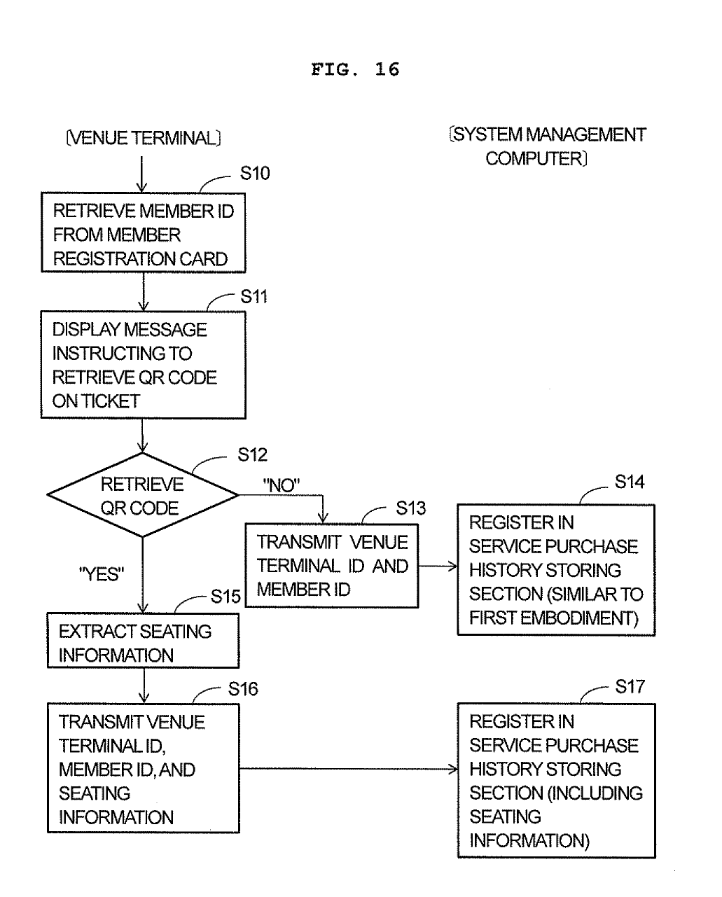

The processing from when the member gains entry until when the seating information is registered by the management computer 4 shall now be described, with reference to FIG. 16.

The member goes to the service provision premises and causes the member ID retrieving section 3a of the venue terminal 3 installed in the premises to read the member registration card 6 (step S10). The venue terminal 3 then uses a screen display, audio, or other section to prompt the member to retrieve the QR code on the ticket (step S11).

A member who has no ticket or who does not wish to imprint the seating information will not cause the QR code to be retrieved (“NO” in step S12″); therefore, the member ID transmitting section 3b transmits the member ID and the relevant terminal ID to the management computer 4 (step S13). The management computer 4, similarly with respect to the first embodiment, registers the service purchase history of the relevant member into the storing section 14 (step S14).

In a case where the venue terminal 3 has retrieved the QR code (“YES” in step S12), the seating information is extracted from the QR code (step S15), and the member ID transmitting section 3b transmits the seating information together with the member ID and the relevant terminal ID to the management computer 4 (step S16). The management computer 4 registers the service purchase history of the relevant member, including the seating information, in the storing section 14 (step S17).

Even when the venue terminal 3 is not provided with a retrieval function for QR codes, the seating information can still be transmitted to the management computer 4 from the premises when the member has brought a member terminal 1 that has a camera function. For example, immediately after causing the venue terminal 3 to retrieve the member ID, the member may use a member terminal 1 that has a camera function to retrieve the seating information from the QR code, the seating information then being transmitted to the management computer 4 together with the venue terminal ID.

In the aforementioned first and second embodiments, it is possible for the commemorative printed article to be issued either on a paid or free basis, but when the issuance is paid, the contractor can obtain revenue not only from providing the service but also from selling the official photograph.

There is no particular limitation to the method of payment in a case where the issuance is paid. There is also no particular limitation to the method for delivering the issued printed article or other item to the member.

To restrict who can view the screen P2 on which the services list is displayed, as in FIG. 10, a password may be inputted together with the member ID as appropriate, thus performing a user authentication. In a case where the member uses a portable telephone to access the system, the specific model information of the portable telephone may be used instead of a password. In short, it is important to perform user authentication to allow only the person who actually benefited from the service and registered in the system to purchase the official photograph. The printed article of the system is endowed with greater value by the limitation on who is permitted to obtain the official photograph.

The management computer 4 may be provided with a separate point-granting section, a member who uses the system to purchase a photograph then being granted points in accordance with the number of uses.

In a case where the same contractor provides the same service using a plurality of agents (which could be, for example, a plurality of actors in a play), then photos of each of the individual agents may be stored in association with an ID identifying the relevant agent, and the number of photos sold for each of the agents may be counted. The effect is essentially that of a popular vote.

The descriptions in the embodiments above employ the examples of theatre-going, sporting matches, and other events, but the system can also be used in a case where a tangible product is purchased. For example, in cases such as when a famous foreign brand opens a store and becomes popular, then a product will serve as a commemorative product having value for the buyer when imprinted with the date purchased, a photograph, and/or the name of the buyer. For example the embodiments described above can be adopted by installing a venue terminal of the present invention at the cash register and causing the venue terminal to retrieve the member card at the time of payment, by either cash or credit card.

In short, the embodiments above have all been illustrated by way of example and are in no way restrictive. Accordingly, for example, various different data structures and processing flows for storing in each of the storing sections 10 to 14, beyond the description above, are conceivable.

Further, although the member terminal 1 and the member registration card 6 are described as being separately configured in each of the embodiments above, the functions of both the member terminal 1 and the member registration card 6 may be implemented in a single PDA terminal or portable telephone terminal.

In such a case, for example, the portable telephone terminal has a built-in IC chip, the member ID then being stored in the IC. The venue terminal 3 can then, by retrieving the member ID stored in the IC, ascertain who has arrived.

The user can also access the main screen (P1) adapted for the purchase of a commemorative article from the portable telephone terminal and request to purchase the commemorative article therefrom.

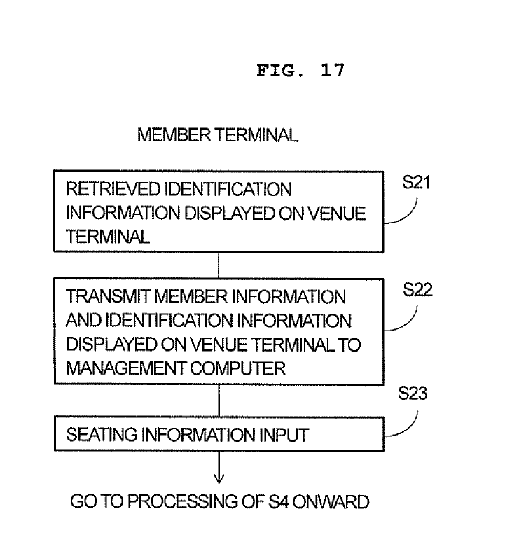

As yet another example, the venue terminal 3 displays identification information (barcode information or the like) for identifying the premises and/or event, as illustrated in FIG. 17. The content of the identification information may be made to vary for each event.

Then, the member terminal 1 retrieves the identification information displayed on the venue terminal 3 (S21) and transmits the retrieved identification information and member information to the management computer 4, and the management computer 4 ascertains which member has come to which premises (event) (S22).

In addition, the member's attendance information is inputted from the member terminal 1 and transmitted to the management computer 4 (S23). Thereafter, the previously described processing of S4 is then performed.

The input of the seating information may also be such that the seating information written on the ticket or the like is retrieved and transmitted. In an exposition or other venue lacking seating, the input of the seating information may be omitted.

According to the examples described above, the relevant member is able, by retrieving the identification information of the venue terminal 3, to purchase a commemorative printed article corresponding to the event which he has been confirmed to have attended.

The aforementioned example in FIG. 17 describes an example in which the venue terminal 3 is made to display the identification information (barcode information or the like) for identifying the premises or event, but infrared light or radio communication may also be used to transmit the same to the member terminal 1 without there being such a display on the venue terminal 3.

Also, although the venue terminal 3 was employed in the example in FIG. 17, the venue terminal 3 may also not be used. In such a case, the identification information for identifying the premises and/or event may be imprinted on paper and then posted at a predetermined location at the venue, or may be displayed on an electronic bulletin board or the like. The identification information for identifying the premises and/or event may also be printed on the ticket for the event.

The aforementioned member registration card 6 may be issued as a dedicated card, but an IC card riding ticket for riding transportation can also be used.

In such a case, a card reader is used to retrieve the ID of the IC card riding ticket at the time of initial registration, and the retrieved ID is then stored in the individual member information storing section 10 in association with the member ID of the relevant user.

The member ID can thereby be ascertained by reference to the individual member information storing section 10 on the basis of the ID of the IC card riding ticket retrieved by the venue terminal 3 at the time of entry.

Furthermore, in such a case, a picture, photograph, text, or other item pertaining to the relevant event or the like, can be printed on the surface of the IC card riding ticket for the user, whereby the user can be provided with an improved amenity.

### INDUSTRIAL APPLICATION

A contractor who provides a variety of different services can implement a user amenity such as the present invention at low cost. By providing the user with a detailed amenity as in the present invention, a participating contractor is also able to increase the number of regular customers for the service.

### DESCRIPTION OF THE REFERENCE NUMERALS

1 Member terminal
2 Contractor terminal
3 Venue terminal
4 Management computer
5 Printing device
6 Member registration card
10 Individual member information storing section
11 Individual contractor information storing section
12 Service information storing section
13 Venue terminal information storing section
14 Service purchase history storing section
18 Service purchase history registration section
19 Service list drafting section
20 Output information generation section

1. A system for issuing a commemorative printed article, by which, in a case where a member who partners with a contractor providing a service and is issued a membership registration card has purchased the service provided by the partnering contractor, the member can acquire an image-bearing commemorative printed article provided by the partnering contractor,
the system for issuing a commemorative printed article characterized in that
a computer for managing the system is communicatively connected to a contractor terminal to be used by the contractor, a venue terminal installed at a location where the service is provided, a member terminal to be used by the member, and a printing device for issuing the commemorative printed article;
the venue terminal being provided with a retrieving section for retrieving member identification information recorded on the member registration card retained by the member; and
a transmitting section for transmitting, to the management computer, the previously retrieved member identification information as well as terminal identification information on the venue terminal, the management computer comprising:
an individual member information storing section for storing individual member information together with the member identification information;
an individual contractor information storing section for storing contractor information on the partnering contractor together with the contractor identification information;
a venue terminal information storing section for storing the correspondence between the terminal identification information and the service identification information;
a service information storing section for storing image data and information pertaining to the service provided by the partnering contractor, in association with the service identification information;
a service purchase history storing section for storing the service identification information on the service provided to the member, in association with the member identification information;
a service purchase history registration section for seeking, upon receipt of the venue terminal identification information and the member identification information from the venue terminal, the received venue terminal identification information from the venue terminal information storing section, extracting the corresponding service identification information, and registering the extracted service identification information and the received member identification information in mutual association in the service purchase history storing section;
a services list drafting section for extracting the service provided to the member from the service information storing section on the basis of the member identification information in response to a request from the member terminal to issue the commemorative printed article, and drafting data for a webpage for displaying the extracted services list and then transmitting the same to the member terminal; and
an output information generating section for extracting, upon receipt of selected and specified information on a service and an official photograph thereof from the member terminal via the webpage, the specified service information and official photograph image data from the service information storing section and the individual contractor information storing section, the individual member information also being extracted from the individual member information storing section, and for integrating the extracted items of information and generating data adapted to be outputted by the printing device.

2. The system for issuing a commemorative printed article according to claim 1, characterized in that
the contractor providing the service is a plurality of business types and a plurality of contractors providing a variety of different services.

3. The system for issuing a commemorative printed article according to claim 1, characterized in that
the service purchase history registration section also additionally registers, in the service purchase history storing section, the individual information transmitted from the member terminal, and
the individual information includes at least one of a seating number from when the service was provided, a message of the actual member or an affiliated person, or image data created by the member

4. The system for issuing a commemorative printed article according to claim 1, characterized in that
the data adapted to be outputted by the printing device for all services provided by the partnering contractor(s) has a shared format.

5. The system for issuing a commemorative printed article according to claim 1, characterized in that
the management computer is managed and administered by an SNS administrator, and the member is also a member of the SNS.

6. The system for issuing a commemorative printed article according to claim 1, wherein:
the member registration card and the member terminal comprise an integrated communication terminal.

7. A method for issuing a commemorative printed article in which, in a case where a member who partners with a contractor providing a service and is issued a membership registration card has purchased the service provided by the partnering contractor, the member can acquire an image-bearing commemorative printed article provided by the partnering contractor,
the method for issuing a commemorative printed article characterized in that
a computer communicatively connected to a contractor terminal to be used by the contractor, a venue terminal installed at a service provision location in order to retrieve member identification information from the member registration card, a member terminal to be used by the member, and a printing device for issuing the commemorative printed article
is capable of accessing
an individual member information storing section for storing individual member information together with the member identification information;
an individual contractor information storing section for storing contractor information on the partnering contractor together with the contractor identification information;
a venue terminal information storing section for storing the correspondence between the venue terminal identification information and service identification information;
a service information storing section for storing image data on an official photograph and information pertaining to the service provided by the partnering contractor, in association with the service identification information;
a service purchase history storing section for storing the service identification information on the service provided to the member, in association with the member identification information; and
a service purchase history registration section for storing the service identification information of the service provided to the member, in association with the member identification information;
and executes processing including:
a step in which, upon receipt of the venue terminal identification information and member identification information from the venue terminal, the received venue terminal identification information is searched from the venue terminal information storing section to extract the corresponding service identification information, the extracted service identification information and the received member identification information then being registered in mutual association in the service purchase history storing section;
a services list drafting step for extracting the service provided to the member from the service information storing section on the basis of the member identification information in response to a request from the member terminal to issue the commemorative printed article, and drafting data for a webpage for displaying the extracted services list and then transmitting the same to the member terminal; and
a step in which, upon receipt of selected and specified information on a service and an official photograph thereof from the member terminal via the webpage, the specified service information and official photograph image data are extracted from the service information storing section and the individual contractor information storing section, the individual member information also being extracted from the individual member information storing section, and the extracted items of information are integrated and data adapted to be outputted by the printing device is generated.

8. The method for issuing a commemorative printed article according to claim 7, characterized in that
the member registration card and the member terminal comprise an integrated communication terminal.
